(19) United States
(12) Patent Application Publication
(10) Pub. No.: US 2026/0270619 A1
(43) Pub. Date: Sep. 10, 2026

(54) INFORMATION HANDLING SYSTEM MODULARIZED SPEAKER

(71) Applicant: Dell Products L.P., Round Rock, TX (US)

(72) Inventors: Jace W. Files, Round Rock, TX (US); Brandon J. Brocklesby, Pflugerville, TX (US); John Trevor Morrison, Round Rock, TX (US); Preeth K. Srinivasan, Round Rock, TX (US)

(73) Assignee: Dell Products L.P., Round Rock, TX (US)

(21) Appl. No.: 19/074,821

(22) Filed: Mar. 10, 2025

(51) Int. Cl. H04R 5/04; G06F 1/16; G06F 3/16; H04R 1/02; H04R 3/12; H04R 5/02; H04S 3/00; H04S 7/00

(52) U.S. Cl. CPC H04R 5/04; G06F 1/1688; G06F 3/162; H04R 1/028; H04R 3/12; H04R 5/02; H04S 3/008; H04S 7/308; H04R 2499/15; H04S 2400/01; H04S 2400/05

(57) ABSTRACT

A portable information handling system speaker module has plural positions to accept speakers that each interface with first and second speaker contacts at a speaker module contact. An audio subsystem detects characteristics of each set of first and second speaker contacts to determine speaker positions that have a speaker and then presents audio from the speakers. The speaker contact characteristics can include a resistance associated with a speaker blank that interfaces with the first and second speaker contacts when a speaker is not present and an impedance that defines the range of audio signals supported by the speaker when present.

### BACKGROUND OF THE INVENTION

### FIELD OF THE INVENTION

The present invention relates in general to the field of portable information handling systems, and more particularly to an information handling system modularized speaker.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems integrate processing components, a display and a power source in a portable housing to support mobile operations. Portable information handling systems allow end users to carry a system between meetings, during travel, and between home and office locations so that an end user has access to processing capabilities while mobile. Tablet configurations typically expose a touchscreen display on a planar housing that both outputs information as visual images and accepts inputs as touches. Convertible configurations typically include multiple separate housing portions that couple to each other so that the system converts between closed and open positions. For example, a main housing portion integrates processing components and a keyboard and rotationally couples with hinges to a lid housing portion that integrates a display. In a clamshell configuration, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility.

Information handling systems provide communication and entertainment functions. For example, information handling systems support videoconferencing that presents visual images and audio of participants communicated across a network. As another example, information handling systems present movies with audiovisual information at integrated displays and speakers. With a portable information handling system, the quality of presentation of audio information can vary significantly based upon the number and types of speakers included in the portable housing. For instance, an information handling system that supports enterprise operations like videoconferencing might include a less expensive speaker configuration than an information handling system that supports personal use like watching movies and playing music. Variations in speaker configurations can include the types of speakers used in the system and the number of speakers used in the system.

One difficulty with presenting audio at an information handling system is ensuring that speakers selected for an information handling system match the physical size available in the housing and also the audio playback constraints. When a portable housing has a defined space available to accept speakers, care is needed at assembly to ensure that a compatible speaker is inserted in the space. If a speaker is inserted that is not compatible with an audio subsystem, then the speakers and/or the audio subsystem can experience damage if audio is played outside of the specified range.

### SUMMARY OF THE INVENTION

Therefore, a need has arisen for a system and method which assembles a speaker module in an information handling system with different speaker capabilities while maintaining audio playback within system constraints.

In accordance with the present invention, a system and method are provided which substantially reduce the disadvantages and problems associated with previous methods and systems for including speakers to play audio at a portable information handling system housing. A speaker module has plural speaker positions selectively populated with speakers to present audio signals as audible sound. Characteristics associated with first and second contacts of each speaker position are measured to determine whether to play audio signals at each speaker position.

More specifically, an information handling system processes information with a processor and memory coupled in a portable housing. An audio subsystem interfaced with the processor further processes information to generate audio signals for presentation at speakers as audible sounds. A speaker module couples in the portable housing to interface with the audio subsystem through a speaker module contact having plural sets of first and second speaker contacts, each set of first and second speaker contacts interfaced with a speaker position that selectively holds a speaker. In one embodiment, a current is applied to detect a resistance associated with each speaker position to identify the speaker positions having speakers. In another embodiment, a nominal audio signal is applied to detect an impedance associated with each speaker position to identify speaker positions having speakers and the audio signal drive range for each speaker position. Audio signals are communicated by the audio subsystem to speaker positions that have a speaker and at a drive range determined for the speakers.

The present invention provides a number of important technical advantages. One example of an important technical advantage is that an information handling system speaker module selectively configures with speakers at plural speaker positions to adapt to different sound outputs. Speakers are automatically detected in speaker positions to determine which speaker sets of first and second speaker contacts receive speaker signals to generate audio.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a portable information handling system having a speaker module configured to selectively populate speaker positions with speakers;

FIGS. 2A and 2B depict a speaker module selectively populated at speaker positions with speakers and speaker blanks;

FIG. 3 depicts a circuit block diagram of a system configured to adapt presentation of audio based upon selective population of speaker module speaker positions;

FIG. 4 depicts a flow diagram of a process for configuring presentation of audio based upon selective population of speakers at speaker module speaker positions;

FIG. 5 depicts a side perspective view of a speaker module selectively populated with speakers and speaker blanks;

FIGS. 6A, 6B and 6C depict an electrical diagram of speakers and speaker blanks installed in a speaker module; and

FIG. 7 depicts an electrical diagram of a speaker interfaced with a comparator circuit to detect the speaker impedance.

### DETAILED DESCRIPTION

A portable information handling system accepts a speaker module selectively populated with speakers and automatically configured to present audio based upon characteristics detected for the speakers. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

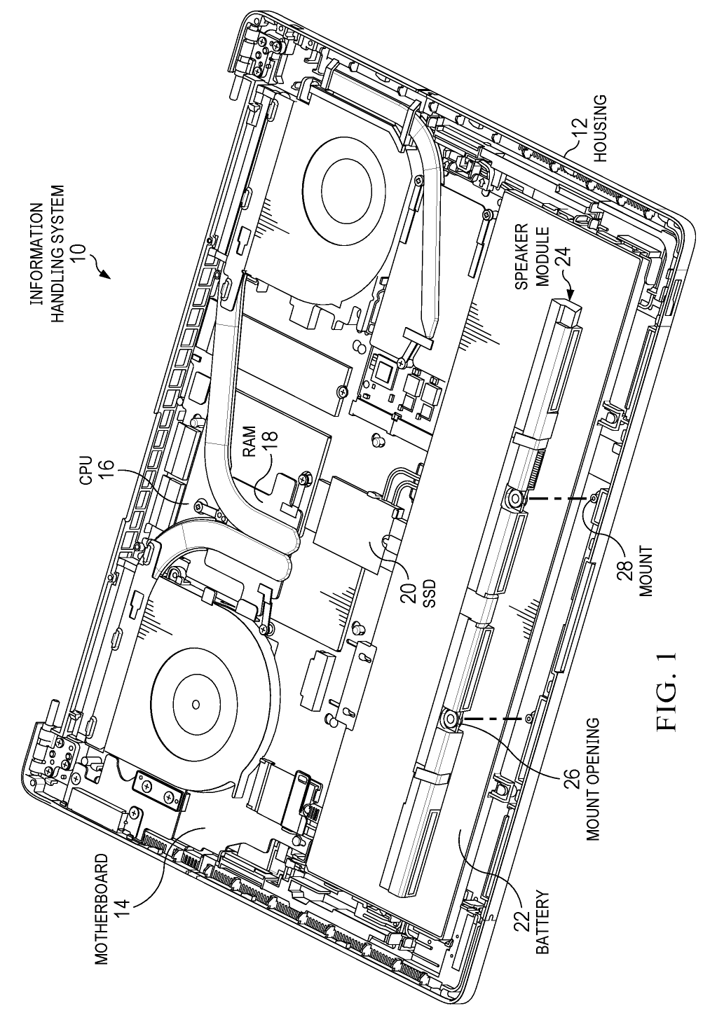

Referring now to FIG. 1, a portable information handling system is depicted having a speaker module 24 configured to selectively populate speaker positions with speakers. In the example embodiment, information handling system 10 is a portable system built in a portable housing 12 having a motherboard 14 that couples a central processing unit (CPU) 16 cooperatively interface with a random access memory (RAM) 18 to execute instruction that process information. A solid state drive (SSD) 20 provides non-transient memory to store the information and instructions during system power down, such as an operating system and audio information. A battery 22 couples in portable housing 12 to provide power to the processing components. Speaker module 24 couples to portable housing 12 with mount openings 26 that fit over mounts 28 to compress against battery 22 with a keystone feature as described in US Patent Application Serial No. 19/035,138, filed January 23, 2025, entitled “Information Handling System Speaker Module with Quick Connection and Battery Retention,” by Tsen et al., and incorporated herein as if fully set forth.

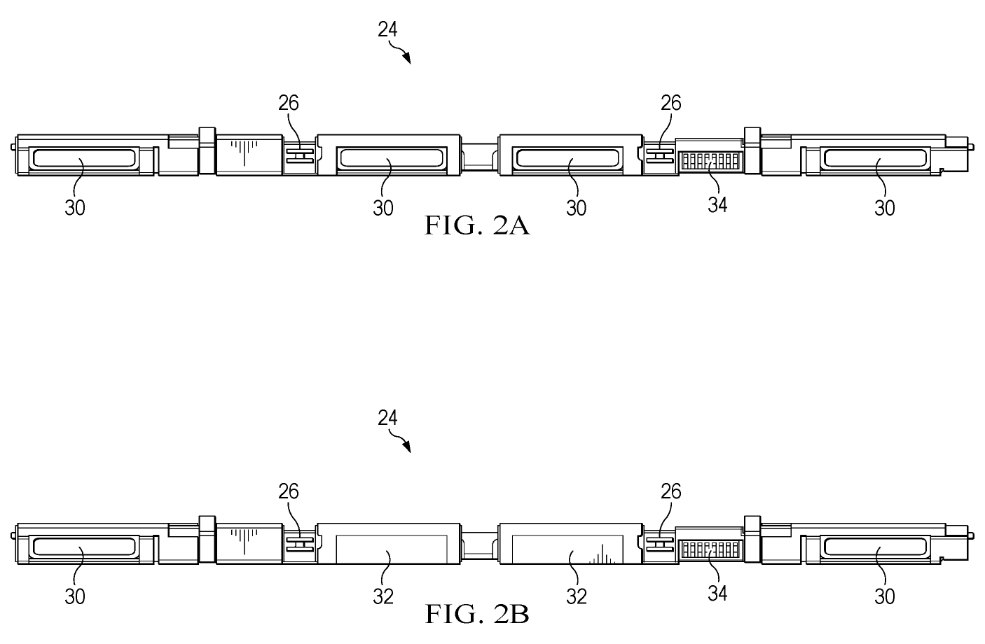

Referring now to FIGS. 2A and 2B, a speaker module 24 is depicted selectively populated at speaker positions with speakers 30 and speaker blanks 32. Speaker module 24 has a pair of mount openings 26 that insert over a mounting pin to couple in place in the portable housing. FIG. 2A depicts speaker module 24 configured with four speakers 30 that generate audible sounds based upon speaker signals communicated to a speaker module connector 34 having eight exposed spring contacts aligned to interface with a bus of the portable housing. Each speaker is interfaced with first and second of the spring contacts to receive a speaker audio signal from an audio subsystem of the information handling system. FIG. 2B depicts speaker module 24 configured with first and second speakers 30 at opposing end speaker positions and first and second speaker blanks 32 in the middle two speaker positions. As is set forth in greater detail below, blanks 32 complete the circuit between the set of first and second speaker contacts of speaker module contacts 34 with an intervening resistor that identifies the speaker position as populated by a speaker blank.

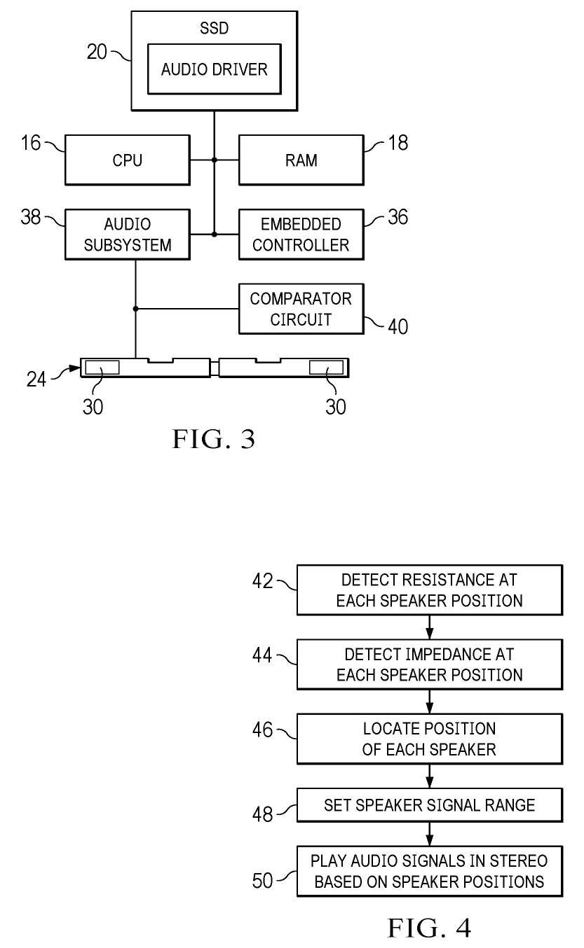

Referring now to FIG. 3, a circuit block diagram depicts a system configured to adapt presentation of audio based upon selective population of speaker module speaker positions. CPU 16 and RAM 18 execute an operating system stored in SSD 20 that includes an audio driver to manage an audio subsystem 38. Audio subsystem 38 includes a processing resource, such as an MCU, a non-transient memory, such as a flash memory, and a CODEC that generates an audio signal from audio information for communication to a speaker 30 to play as audio sounds. When a speaker module 24 is detected, audio system 38 executes instructions in the flash memory to identify speakers 30 coupled to the speaker module that present audio and then communicates audio signals to speaker module 24 at the speaker contacts associated with speaker positions that are populated by a speaker. Audio subsystem 38 performs the logic internally or alternatively may perform the logic in cooperation with an embedded controller 36 and/or CPU 16. In one embodiment, audio subsystem 38 sends a DC current to each set of first and second speaker contacts to detect speakers and speaker blanks by the difference in resistance across the speaker contacts. In an alternative embodiment, audio subsystem 38 drives a nominal audio signal to each set of first and second speaker contacts to determine an impedance of each set of speaker contacts with a comparator circuit 40. The nominal audio signal has a minimal value that will not cause damage to a small speaker. The impedance indicates whether a speaker populates the speaker position associated with each set of first and second speaker contacts and also indicates the audio signal drive range that each speaker can safely handle. Once the speaker positions are determined that are populated with speakers 30, audio subsystem 38 uses the populated speaker positions to send audio signals in stereo.

Referring now to FIG. 4, a flow diagram depicts a process for configuring presentation of audio based upon selective population of speakers at speaker module speaker positions. At step 42 a resistance is detected at each speaker position, such as by sending a DC voltage current to each speaker position and measuring the return current and/or voltage. At step 44 an impedance is detected at each speaker position, such as by sending a nominal audio signal to each speaker position and measuring the impedance with a comparator circuit. At step 46 the resistance and impedance are analyzed for each speaker position to locating the speaker positions that have a speaker installed. At step 48 the audio signal drive range is set for each speaker based upon the impedance so that the speakers will each operate in a safe range that maximizes available speaker output. At step 50, the audio subsystem plays audio with stereo determined from the detected speaker positions.

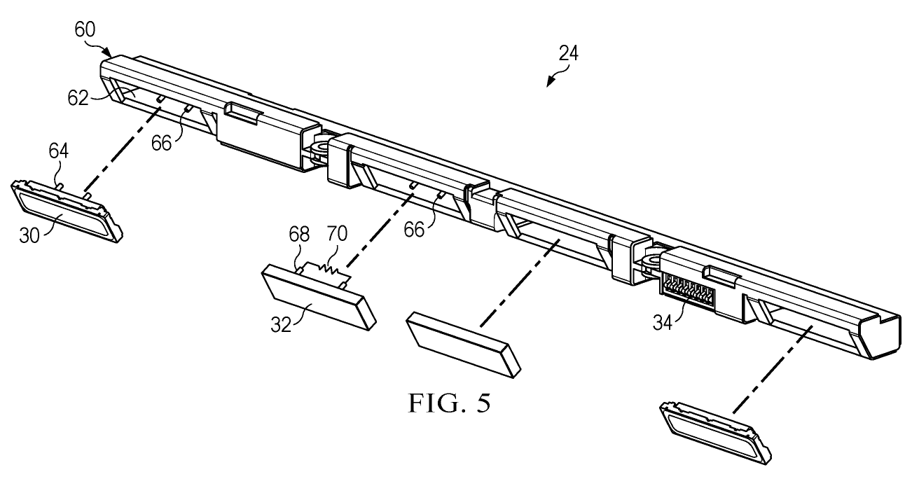

Referring now to FIG. 5, a side perspective view depicts a speaker module 24 selectively populated with speakers 30 and speaker blanks 32. Speakers 30 couple into cavities 62 formed in a body 60 to align speaker contacts 64 with cavity contacts 66, which interface through internal wirelines with first and second speaker contacts of module speaker contact 34. Speaker blanks 32 in the example embodiment include speaker blank contacts 68 that communicate through a resistor 70 and interface with cavity contacts 66. When a current passes through a set of first and second speaker contacts of speaker module 34 to cavity contacts 66, resistor 70 adjusts the current/voltage so that the audio subsystem can detect the speaker position is populated by a speaker blank.

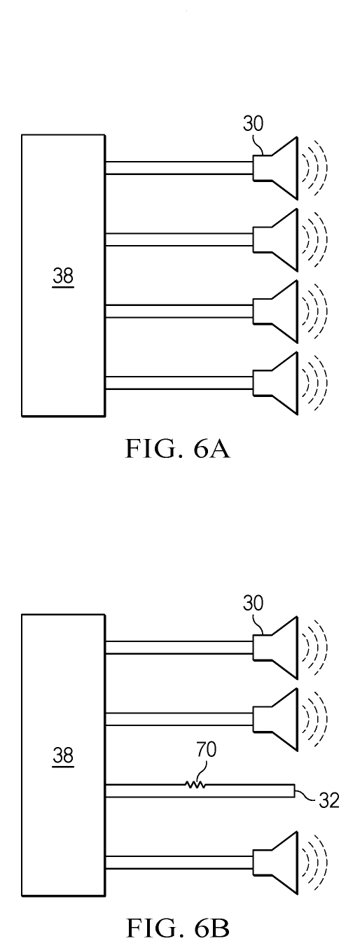

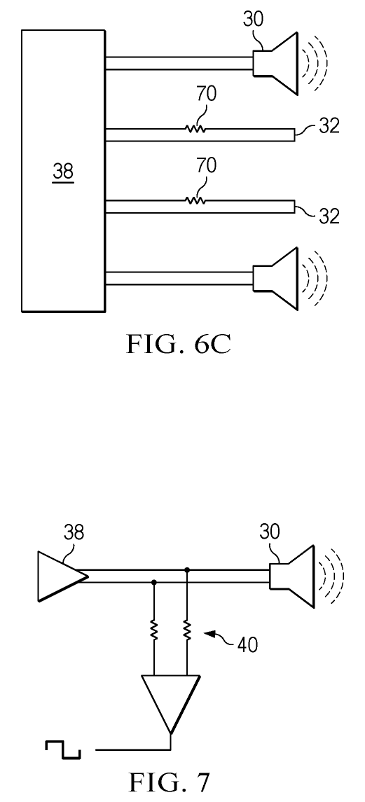

Referring now to FIGS. 6A, 6B and 6C, an electrical diagram depicts speakers 30 and speaker blanks 32 installed in a speaker module. FIG. 6A depicts a speaker module having all four speaker positions populated with speakers 30 so that the audio subsystem 38 detects the nominal resistance of the speakers to indicate that all four speaker positions are populated. FIG. 6B depicts an example embodiment having three speakers 30 and one speaker blank 32. The resistor 32 in speaker blank 32 indicates to audio subsystem 38 that three speaker positions are populated. Audio subsystem 38 then configures the outer speakers to have left and right stereo with the middle speaker having middle audio. FIG. 6C depicts an example embodiment having two speakers 30 and two blanks 32, each blank having a resistor 70 to indicate a blank to the audio subsystem. In the example embodiment, the outer speakers output left and right stereo audio.

Referring now to FIG. 7, an electrical diagram depicts a speaker 30 interfaced with a comparator circuit 40 to detect the speaker impedance. Comparator circuit 40 interfaces with each speaker contact through resistor and amplifier to compare the signal in and return signal for a determination of the impedances of speaker 30. The impedance is analyzed to determine a maximum power for the audio signal to play to the speaker without damage to the speaker.

Although the present invention has been described in detail, it should be understood that various changes, substitutions and alterations can be made hereto without departing from the spirit and scope of the invention as defined by the appended claims.

What is claimed is:

1. An information handling system comprising:
a portable housing;
a processor coupled in the portable housing and operable to execute instructions to process information;
a memory coupled in the portable housing and interfaced with the processor, the memory operable to store the instructions and information;
an audio subsystem coupled to the portable housing and interfaced with the processor, the audio subsystem operable to convert the information to audio signals;
a speaker module having plural speaker positions, at least one of the plural speaker positions having a speaker, each speaker position having first and second speaker contacts interfaced with a speaker module contact, the speaker module contact interfaced with the audio subsystem to receive the audio signals; and
a non-transitory memory storing instructions that when executed cause:
detection at the speaker module contact of a contact characteristic associated with each set of the first and second speaker contacts;
assigning each set of the first and second speaker contacts with a first contact characteristic to receive the audio signals; and
assigning each set of the first and second contacts with a second contact characteristic as blanks that do not receive the audio signals.

2. The information handling system of claim 1 further comprising:
a resistor having a first resistance, the resistor interfaced between the first and second speaker contacts of each set of first and second speaker contacts that do not interface with the speaker;
a current source to apply a current to the speaker module contact to detect a resistance across each set of first and second speaker contacts; and
an instruction stored in the non-transitory memory that when executed:
configures the audio subsystem to send the audio signals to the sets of first and second speaker contacts at which the first resistance is not detected; and
configures the audio subsystem to not send audio signals to the sets of first and second speaker contacts at which the first resistance is detected.

3. The information handling system of claim 2 further comprising a speaker blank sized to fit in a speaker position and having the resistor configured to interface with the set of first and second speaker contacts of the speaker position.

4. The information handling system of claim 2 further comprising instructions stored in the non-transitory memory that when executed cause:
identification of each speaker position having a speaker; and
communication of the audio signals to the speakers in stereo based upon the speaker positions.

5. The information handling system of claim 1 further comprising:
a comparator circuit interfaced with each set of first and second speaker contacts; and
instructions stored in the non-transitory memory that when executed cause:
drive of nominal audio signals to each set of first and second speaker contacts; and
analyze impedance of each set of first and second speaker contacts to detect speaker positions interfaced with a speaker and speaker positions not interfaced with a speaker.

6. The information handling system of claim 5 further comprising an instruction stored in the non-transitory memory that when executed causes application of the impedance of each speaker position to set at each speaker an audio signal drive range.

7. The information handling system of claim 6 further comprising an instruction stored in the non-transitory memory that when executed causes communication of the audio signals to the speakers in stereo based upon the speaker positions.

8. The information handling system of claim 1 wherein the speaker module further comprises:
a body having four cavities, each cavity having a set of the first and second speaker contacts;
at least one speaker sized to fit in one of the four cavities and interfaced with the first and second speaker contacts to receive the audio signals; and
at least one speaker blank sized to fill one of the four cavities when not populated by a speaker.

9. The information handling system of claim 8 further comprising a resistor coupled in the blank to interface between the first and second speaker contacts.

10. A method for presenting audio at a portable information handling system, the method comprising:
detecting at a speaker module contact a contact characteristic associated with each set of first and second speaker contacts;
assigning each set of the first and second speaker contacts having a first contact characteristic to receive audio signals from an audio subsystem; and
assigning each set of the first and second contacts having a second contact characteristic as blanks that do not receive the audio signals.

11. The method of claim 10 further comprising:
sending a current to each set of first and second speaker contacts;
detecting a resistance associated with each set of first and second speaker contacts;
configuring the audio subsystem to send the audio signals to the sets of first and second speaker contacts at which a first resistance is not detected; and
configuring the audio subsystem to not send audio signals to the sets of first and second speaker contacts at which the first resistance is detected.

12. The method of claim 11 further comprising:
coupling at least one speaker in at least one of plural speaker positions of a speaker module;
coupling at least one speaker blank in at least one of the plural speaker positions, the at least one speaker blank having a resistor of the first resistance interfaced with the first and second speaker contacts associated with the at least one speaker position.

13. The method of claim 12 further comprising:
determining plural of the speaker positions that have a speaker; and
communicating audio signals to the speakers in stereo based upon the speaker positions.

14. The method of claim 10 further comprising:
driving a nominal audio signal to each set of first and second speaker contacts;
detecting the nominal audio signals at each set of first and second speaker contacts with a comparator to determine an impedance associated with each set of first and second speaker contacts;
configuring the audio system to communicate audio signals to play audio to the sets of first and second speaker contacts having a first impedance; and
configuring the audio system to not communicate audio signals to play audio to the sets of first and second speaker contacts having a second impedance.

15. The method of claim 14 further comprising applying the impedance of each of the first and second sets of speaker contacts to set at each speaker an audio signal drive range.

16. A system for presenting audio at an information handling system, the system comprising:
an audio subsystem operable to convert information to audio signals;
a speaker module having plural speaker positions, at least one of the plural speaker positions having a speaker, each speaker position having first and second speaker contacts interfaced with a speaker module contact, the speaker module contact interfaced with the audio subsystem to receive the audio signals; and
a non-transitory memory storing instructions that when executed cause:
detection at the speaker module contact of a contact characteristic associated with each set of the first and second speaker contacts;
assigning each set of the first and second speaker contacts with a first contact characteristic to receive the audio signals; and
assigning each set of the first and second contacts with a second contact characteristic as blanks that do not receive the audio signals.

17. The system of claim 16 further comprising:
a resistor having a first resistance, the resistor interfaced between the first and second speaker contacts of each set of first and second speaker contacts that do not interface with the speaker;
a current source to apply a current to the speaker module contact to detect a resistance across each set of first and second speaker contacts; and
an instruction stored in the non-transitory memory that when executed:
configures the audio subsystem to send the audio signals to the sets of first and second speaker contacts at which the first resistance is not detected; and
configures the audio subsystem to not send audio signals to the sets of first and second speaker contacts at which the first resistance is detected.

18. The system of claim 17 further comprising:
a comparator circuit interfaced with each set of first and second speaker contacts; and
instructions stored in the non-transitory memory that when executed cause:
drive of nominal speaker signals to each set of first and second speaker contacts; and
analyze impedance of each set of first and second speaker contacts to detect speaker positions interfaced with a speaker and speaker positions not interfaced with a speaker.

19. The system of claim 18 further comprising a speaker blank sized to fit in a speaker position and having the resistor configured to interface with the set of first and second speaker contacts of the speaker position.

20. The system of claim 19 further comprising instructions stored in the non-transitory memory that when executed cause:
identification of each speaker position having a speaker; and
communication of the audio signals to the speakers in stereo based upon the speaker positions.
